(19) United States
(12) Patent Application Publication
(10) Pub. No.: US 2001/0032744 A1
(43) Pub. Date: Oct. 25, 2001

(54) Steering ski for snow vehicles

(76) Inventor: Takashi Moriyama, Iwata (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/746,709

(22) Filed: Dec. 22, 2000

(30) Foreign Application Priority Data
Apr. 24, 2000 (JP) 2000-122951184469

(51) Int. Cl. B62B 13/08; B62M 27/00

(52) U.S. Cl. 180/182; 280/28

(57) ABSTRACT

A steering ski for a snowmobile comprises a ski body and a reinforcing member. The steering ski has a flat portion for contacting the surface of the ground and an upturned leading portion. The reinforcing member is connected to the upturned leading portion at multiple connection points. The ski and the reinforcing member are coupled to transmit forces in a way that reduces the pressure in the upturned leading portion. The forces are applied to the ski when the snowmobile strikes obstructions in its path and when it lands after becoming airborne. A stopper is provided to transmit the forces.

### PRIORITY INFORMATION

This application is based on and claims priority to Japanese Patent Application No. 2000-122951, filed Apr. 24, 2000, the entire contents of which is hereby expressly incorporated by reference.

### BACKGROUND OF THE INVENTION

1. Field of the Invention

The present invention generally relates to steering skis for snow vehicles. More particularly, the present invention relates to reinforcing members for such steering skis.

2. Description of the Related Art

Snowmobiles and similar snow vehicles have become increasingly popular in recent years for both utilitarian and recreational use. The vehicles typically are adapted to carry one or more riders across snow and/or ice and usually include one or more forward facing skis along with a driven belt track or other propulsion mechanism, such as wheels, for instance.

Although the recreational use of such snowmobiles is often practiced on groomed trails, the snowmobile may encounter trail hazards. For example, the rider may encounter obstructions, such as ice chunks or small snow or ice mounds on such trails. Also, the rider and the snowmobile may momentarily become airborne upon encountering these mounds, larger bumps or dips. Both of these conditions could be detrimental if the snowmobile skis were flat and horizontally mounted because the ski and/or the snowmobile could be damaged by colliding with the obstructions or by becoming lodged in snow-pack. Although often operated on groomed trails, snowmobiles may also venture into snow and or ice-fields that have no trails. In this situation, a horizontal and flat ski would increase the likelihood of becoming lodged in snow-pack.

To address these hazards, snowmobiles are designed with skis generally having two distinct portions: an upturned leading portion and a horizontal sliding snow contacting portion upon which the forward portion of the snowmobile glides. The snow contacting portion provides for smooth and efficient sliding contact with the trail, carries the forward weight of the vehicle and responds to the rider's steering input. The upturned leading portion prevents the snowmobile ski from getting stuck on an obstruction or from getting lodged in snowpack. The upturned leading portion either pushes the obstruction aside or helps the snowmobile to ride up and over the obstruction rather than becoming lodged in it.

A reinforcing member can be attached to the ski in the upturned leading portion. Often, the reinforcing member is connected in at least one location along the upturned section using pin or bolt type connections. In some arrangements, both the ski and the reinforcing member are made of cured synthetic resin. This allows the upturned leading portion to flex when it comes in contact with an obstruction in the snowmobile's path or when the vehicle lands after becoming airborne. Being flexible, the skis can absorb impact without breaking or being otherwise permanently deformed.

However, the ski can still break or be permanently deformed if it is subjected to large pressures. This can occur in existing ski configurations at the connection point between the reinforcing member and the ski because the impact and landing forces are transmitted through relatively small surface area at the connection points. Because the point of connection is relatively small, forces transferred to the ski from striking obstructions or landing after becoming airborne create large pressures, or stresses, around those connection points. If these stresses exceed the yield point of the ski material, the ski will plastically deform.

Ski deformation is very undesirable. The ski shape often is optimized for a smooth ride, for enhanced handling characteristics and, of course, for a pleasing appearance. Plastic deformation of such an optimized ski takes it out of the desired shape. This can make the snowmobile less enjoyable to drive and can make handling more difficult, especially at high vehicle speeds. Of course, the appearance of a mangled snowmobile ski is also less attractive. In addition to decreasing the performance of the ski, fatigue (repeated plastic deformation of the ski) can further weaken the structural integrity of the ski. After a finite number of deformation cycles, the ski can reach its stress point and fracture.

A need therefore exists for an improved connection between the snowmobile ski reinforcing member and the ski body. The ski and the reinforcing member should be configured to transmit the forces of obstruction impact and landing in such a way that plastically deformation of the snowmobile ski is lessened. Preferably, the reinforcing member would be shaped and connected to the snowmobile ski so that the reinforcing member would provide additional reinforcement to the ski during these stressed conditions. Additionally, the reinforcement provided by the reinforcing member could be either in front of or behind the points of connection. Furthermore, the reinforcement could be achieved by coupling surfaces on both the ski and the reinforcing member.

### SUMMARY OF THE INVENTION

One aspect of the present invention provides a connection configuration between a reinforcing member and the upturned leading portion of a ski body which counteracts pressure concentration in the ski when impacting an obstruction in the vehicle's path or landing after the vehicle becomes airborne.

Another aspect of the present invention reduces pressures applied to the snowmobile ski upturned leading portion at the point of reinforcing member connection such that the ski body portion does not undergo plastic deformation.

A further aspect of the present invention involves a ski for a snowmobile comprising a body having a substantially horizontal snow contact section and an upturned forward leading portion. A reinforcing member is connected to the upturned forward leading portion. The reinforcing member is curved so that a portion in front of the point of connection is adjacent to the rear side of the upturned forward leading portion, providing reinforcement.

Another aspect of the present invention involves a snowmobile comprising a body, a pair of skis disposed generally below a forward portion of the body and a drive arrangement disposed generally below a rearward portion of the body. The snowmobile slides on the pair of skis and is powered in at least a forward direction by the drive arrangement. At least one of the skis comprises a flat portion usually in contact with the ground and an upturned forward leading portion which may contact obstructions in the snowmobile's path or may absorb the force of impact after jumping. Connected to at least one of the skis is a reinforcing member. The reinforcing member is configured to provide reinforcement to the upturned forward leading portion.

Another aspect of the present invention involves a snowmobile comprising a body, a pair of skis disposed generally below a forward portion of the body and a drive arrangement disposed generally below a rearward portion of the body. The snowmobile slides on the pair of skis and is powered in at least a forward direction by the drive arrangement. At least one of the skis comprises a flat portion usually in contact with the ground and an upturned forward leading portion which may contact obstruction in the snowmobile's path or may absorb the force of impact after jumping. Connected to at least one of the skis is a reinforcing member. The upturned forward leading portion is configured with a projection. The reinforcing member is configured with a small projection. The reinforcing member and the upturned forward leading portion are assembled so that the projections may contact one-another.

One feature of the present invention involves a ski for a vehicle comprising an upturned leading portion and a reinforcing member fixed to the front of the leading portion at a forward mounting portion and to the rear of the leading portion at a rear mounting portion. The reinforcing member comprises a first stopper configured to partially conform to the surface of the leading portion in front of the forward mounting portion.

Another feature of the present invention involves a ski for a snowmobile comprising an upturned leading portion and a reinforcing member fixed to the front of the leading portion at a forward mounting portion and to the rear of the leading portion at a rear mounting portion. A stopper is disposed along a portion of one of the ski and the reinforcing member.

A further feature of the present invention involves a snowmobile comprising a body, a pair of skis disposed generally below a forward portion of the body and a drive arrangement disposed generally below a rearward portion of the body. The snowmobile slides on the pair of skis and the snowmobile is powered in at least a forward direction by the drive arrangement. At least one of the skis comprises an upturned leading portion, a reinforcing member fixed to the front of the leading portion at a forward mounting portion and to the rear of the leading portion at a rear mounting portion, and a stopper.

Yet another feature of the present invention involves a snowmobile ski comprising a ski body. The ski body comprises a sole and an upturned forward portion. A reinforcing member is connected at a forward end of the forward portion and at a second portion of the ski. The ski further comprises means for limiting relative movement between the forward portion and the ski body.

### BRIEF DESCRIPTION OF THE DRAWINGS

The above and other features, aspects and advantages of the present invention will now be described with reference to drawings that show certain presently preferred arrangements that are intended to illustrate and not to limit the present invention and in which drawings:

FIG. 1 is a side elevation view of a snowmobile having a pair of steering skis arranged and configured in accordance with certain features, aspects and advantages of the present invention;

FIG. 2 is a top plan view of the steering ski of FIG. 1 having reinforcing member through-holes illustrated with hidden lines;

FIG. 3 is an enlarged exploded view of the upturned forward leading portion of the steering ski of FIG. 1 with a reinforcing member broken out from the front and rear connection points;

FIG. 4(a) is a top plan view of the reinforcing member of FIG. 3 removed from the steering ski having certain internal features illustrated with hidden lines;

FIG. 4(b) is a front plan view of the reinforcing member of FIG. 3, having certain internal features illustrated with hidden lines;

FIG. 4(c) is a cross-sectional view of the reinforcing member of FIG. 3 taken along section C-C;

FIG. 5 is an enlarged cross sectional view taken along line 5-5 in FIG. 3 showing the rear reinforcing member connection point and system;

FIG. 6 is an enlarged cross sectional view taken along line 6-6 in FIG. 3 showing the rear reinforcing member bracket and connection system;

FIG. 7 is an enlarged cross-sectional side elevation view of an embodiment of the reinforcing member connection system;

FIG. 8 is an enlarged cross-sectional side elevation view of an embodiment of the reinforcing member connection system shown in a loaded state; and

FIG. 9 is an enlarged exploded view of an upturned forward leading portion of another steering ski similar to that shown in FIG. 1 with another embodiment of the reinforcing member broken out from front and rear connection points.

### DETAILED DESCRIPTION OF THE PREFERRED EMBODIMENT

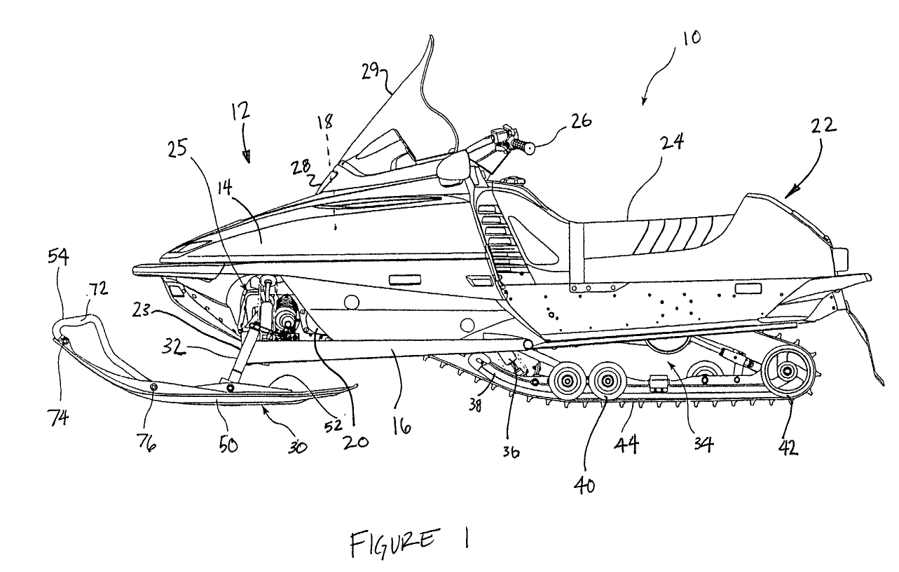

With reference initially to FIG. 1, a snowmobile having a pair of steering skis constructed in accordance with certain features, aspects and advantages of the present invention is identified generally by the reference numeral 10. While the present invention will be described in the context of a snowmobile, it should be readily appreciated that the present invention also can be used in a variety of other applications, such as all terrain vehicles having at least one front ski, for instance. The snowmobile 10 includes a body assembly 12 made up of a number of parts which may be formed from suitable materials. The illustrated body assembly 12 includes an upper engine shroud 14 and a lower tray 16, which together define an engine compartment 18. The engine compartment 18 preferably houses an internal combustion engine 20 for powering the snowmobile 10.

The illustrated body assembly 12 further includes a rear portion 22 that accommodates a seat 24, which is adapted to seat one or more riders in a straddle fashion. A handlebar assembly 26 is positioned in front of the seat 24 for operation by the rider.

The illustrated upper engine shroud 14 includes a raised portion 28 located in front of the handlebar assembly 26. The raised portion 28 carries a windshield 29 to protect the rider from wind, snow, branches and other objects when operating the snowmobile 10.

A pair of front skis 30, constructed as herein described, are supported at a forward portion of the body 12 with a set of suspension struts 32. The suspension struts accommodate steering movement of the skis 30. The struts 32 preferably are interconnected with a tie rod (not shown) so that they can be steered in unison and at least one of the skis 30 preferably has a steering link (not shown) that is connected to a steering rod (not shown). The handlebar assembly 26 is linked to the front skis 30 through the steering rod and a steering column 23 such that movement of the handlebar assembly 26 results in a corresponding steering movement of the front skis 30. In this manner, the operator can control the movement of the vehicle by manipulating the handlebar assembly 26, which in turn manipulates the ski bodies 50 in a manner well known in the art.

A carriage assembly 34 is supported at the rear portion of the body 12 below the seat 24 by a rear suspension system 36. The carriage assembly 34 includes a pair of guide rails 38 that carry a plurality of idler rollers 40, including a main rear idler roller 42.

The guide rails 38 and the idler rollers 40, 42 cooperate to form a path around which a drive track 44 is trained. The drive track 44 preferably is driven by an output shaft (not shown) of the engine 20 through a suitable variable belt-type transmission (not shown), as is well known in the art.

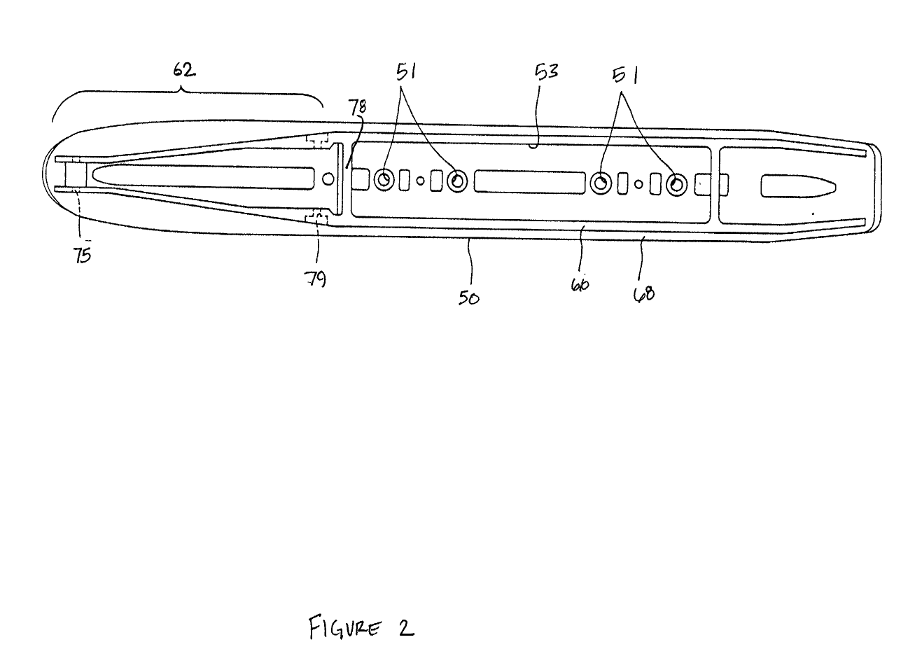

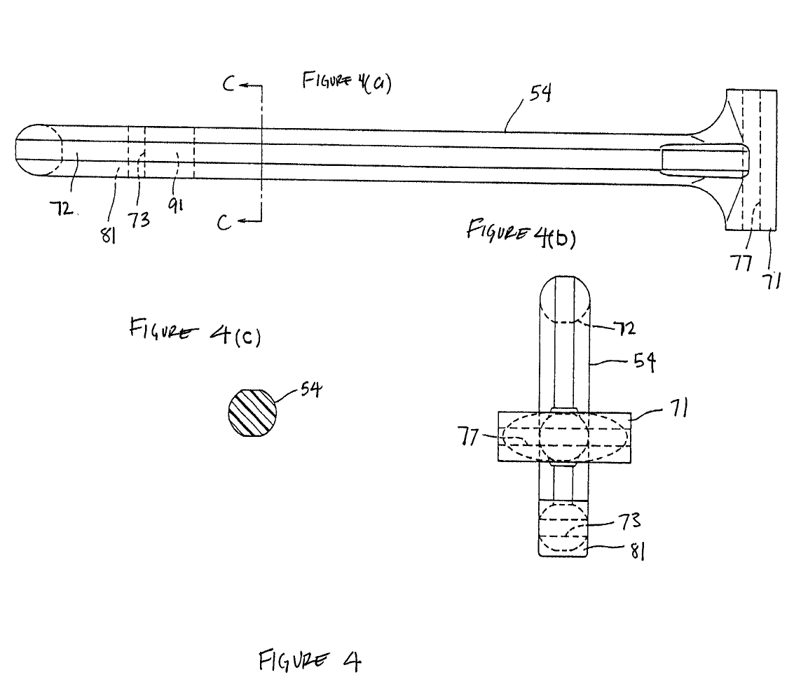

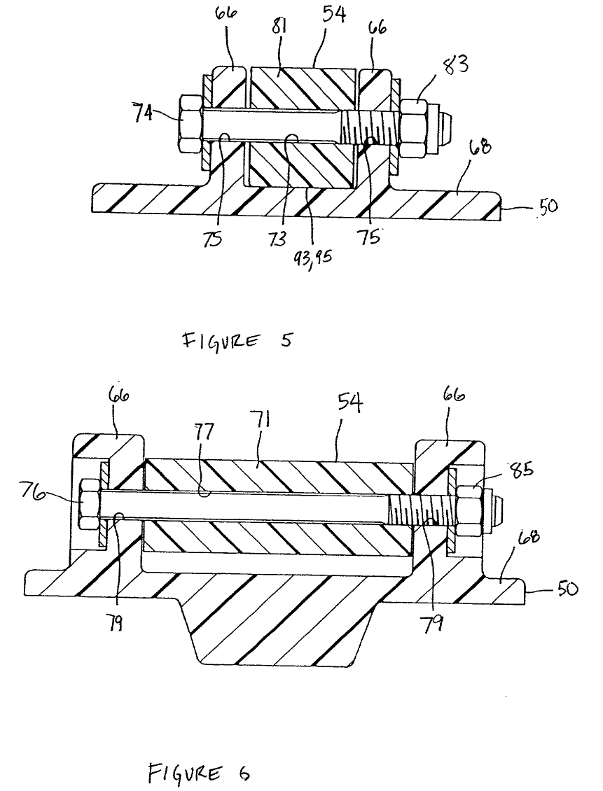

With reference now to FIGS. 2-7, the present ski body 50 will be described in greater detail. The ski body 50 is preferably manufactured from a lightweight yet resilient material. In one arrangement, the material is a polyethylene plastic. Of course, any suitable plastic or composite materials can be used. In addition, metals, woods or other resilient materials can be used. In a presently preferred arrangement, the ski body 50 is manufactured from a material having a density of about 0.93 g/cc and a hardness on the shore D hardness scale of about 60 to about 62. Preferably, this material has an izod impact strength, double notched, of about 80 mJ/mm² or above. In addition, the material preferably has a modulus of elasticity of about 530 MPa. Moreover, the material selected preferably should keep over 80% of its properties after ultraviolet testing according to a test method of JIS D205 WAN-IS at 600 hours. One such material is a UHMW polyethylene that is equivalent to Montell IV 26-32 or Ticona IV 26-32. Both of these materials preferably have 0.15% by weight of a UV stabilizer, such as CHPL17.

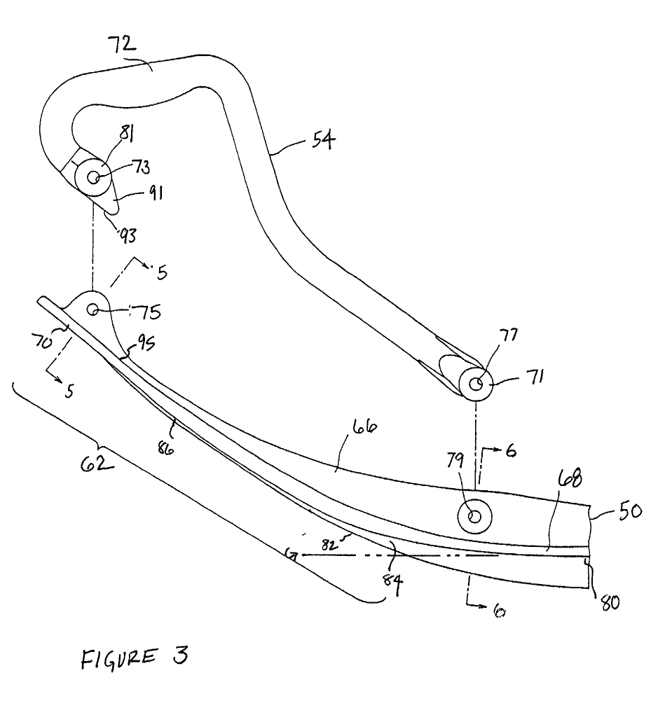

Generally speaking, the ski body 50 forms the member upon which the vehicle 10 planes across a ground surface G. As illustrated in FIG. 3, the ground G typically is covered by snow and, thus, the ski body 50 has a portion that rides beneath the upper surface of the snow and creates an indentation within the snow. The illustrated ski preferably has an overall width that varies with its length. As a general matter, the illustrated ski body 50 has an overall width that decreases from front to back. Desirably, a forward portion 62 of the ski body 50, otherwise known as the upturned leading portion of the ski 30, extends above the upper surface of the snow such that the ski 50 rises above the ground level G during acceleration in a forward direction. In addition, a trailing edge (not shown) of the ski body 50 also can be curved upward away from the ground G such that the vehicle can move rearward without unnecessarily digging the ski 30 into the snow.

The through-holes 51, shown in FIG. 2, are used to connect various components to the ski body 50. For example, a wear bar (not shown) and/or a bracket 52 for mounting the ski body 50 to the vehicle 10 can be secured in the throughholes 51. The bracket 52 may be nested in a recess 53 and may provide for pivotal mounting of the ski body 50 to the suspension strut 32. This connection may be accomplished by any method known in the art, for example, bolts or pins.

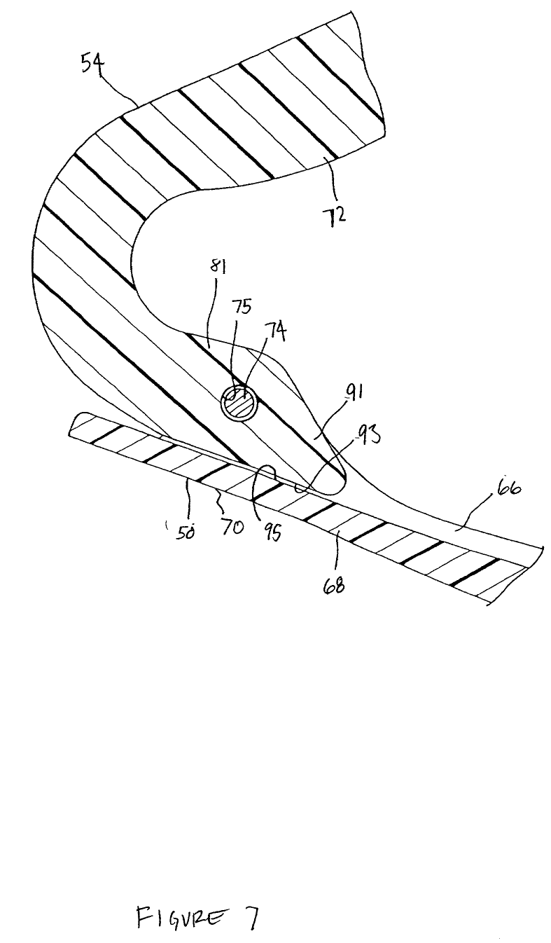

With reference to FIGS. 2 and 3, the ski body 50 also generally comprises a pair of reinforcing ribs 66 that extend along a length of the upper surface of the ski body 50. More particularly, the illustrated reinforcing ribs 66 extend upwardly away from a top surface of a generally planar sole 68 of the ski body 50. The generally square corners of the sole 68 (shown in FIGS. 5 and 6) provide increased cutting action when the snowmobile 10 is sharply turned. Such a feature increases the handling characteristics and maneuverability of the snowmobile. Additionally, at least a portion of the lower surface of the sole 68 may include a pair of outer ridges (not shown). The ridges can extend downward and may improve cornering. Preferably, a central keel is provided that can extend further downward than the outer ridges.

With reference again to FIG. 3, the reinforcing ribs 66 extend from within the upturned leading portion 62 of the ski body 50 and have an increasing height relative to the sole 68 of the ski body 50 and a gradual taper along the length of the ski body 50. Preferably, the height of the reinforcing ribs 66 is maximized just forward of the bracket 52 and just rearward of an attachment location of the reinforcing member 54 in the illustrated arrangement.

The reinforcing member 54 can be attached to a forward portion 70 of upturned leading portion 62, as well as to a location just forward of the ski bracket 52. Preferably, the reinforcing member 54 provides a handgrip 72 that allows an operator to pull the snowmobile 10 by the skis or to manually reposition the skis when the snowmobile 10 is not being operated. Preferably, the reinforcing ribs 66 taper toward one another on the forward portion 62 such that they are separated by a gap generally equal to the thickness of the reinforcing member 54 at the forward-most portion 70 of the ski body 50. The reinforcing member 54 is attached using threaded fasteners, as can be seen in many of the figures. Of course other ways of attaching the reinforcing member 54 to the ski body 50 also can be used. For instance, a pair of bolts could be used, one on each side of the reinforcing member fastened to a threaded bracket mounted between the reinforcing ribs 66. Also, a pin connection could be used. In this type of connection a pin would pass through the through-holes 73, 75 and held in place by a cotter-key or ring. Also, the ski could be made with a receiving member which is circular, but which has a slot. Meanwhile, the reinforcing member 54 could be made with an integral shaft configured to be pressed into the slot.

FIG. 3 shows an exploded view of the two attachment points of a reinforcing member 54, which is arranged and configured in accordance with the present invention. FIG. 5 shows a cross sectional view along line 5-5 in FIG. 3. The reinforcement ribs 66 are provided with through-holes 75. The front end 81 of the reinforcing member 54 preferably is provided with a through hole 73. When assembled, the front end 81 of the reinforcing member 54 is nested between the reinforcing ribs 66 so that a threaded fastener 74 may be passed through the holes 75, 73. Once passed through, a nut 83 can be threaded onto the threaded fastener 74, thereby securing the front end 81 of the reinforcing member 54 in place. When in this position, a pressing surface 93 is positioned on or just above a pressed surface 95. The threaded fastener 74, which is used to attach the reinforcing member 54 to the ski body 50, preferably is tightened to a torque of about 8 to 13 Nm.

In a like manner, FIG. 6 shows a cross sectional view along section 6-6 of the attachment of the tube 71 on a rear portion of the reinforcing member 54. The reinforcing ribs 66 are provided with a recessed through hole 79. The tube 71 of the reinforcing member 54 is provided with a through hole 77. This through hole is sized to accommodate a threaded fastener 76. When assembled, the tube 71 of the reinforcing member 54 is nested between the reinforcing ribs 66 so that the threaded fastener 76 passes through the holes 77, 79. Once passed through, a nut 85 can be threaded onto the fastener 76, securing it in place. This also secures the tube 71 and thus the rear-end of the reinforcing member 54. The rearward threaded fastener 76 is preferably tightened to a torque of approximately 15 to 18 Nm. Additionally, the reinforcing ribs 66 are joined by a crossing member 78 proximate the location of the threaded fastener 76. In this manner, the reinforcing member 54 supports the upturned leading portion 62 of the ski body 50.

With reference now to FIG. 3, and as explained above, the snow contacts the ski body 50 along the sole 68 at a snow contacting portion 80. It is on the snow contacting portion 80 that the majority of the weight of the snowmobile 10 typically is carried. More preferably, and as illustrated, the snowmobile 10 planes across the surface of the snow on the snow contacting portion 80 and a portion of snow is compacted underneath the snow contacting portion 80. The forward portion 86 of the ski body 50 that contacts the snow is connected to the upturned leading portion 62 at a junction 82. Proximate the junction 82 a keel 84 begins to develop. The keel 84, which is similar to that used in watercraft, is used to increase the tracking of the snowmobile 10 through the snow and to enable enhanced cornering abilities. More preferably, and as illustrated, the keel 84 actually begins proximate the forward-most portion 70 of the ski body 50.

With reference now to FIGS. 3-5, 7 and 8, one embodiment of the reinforcing member 54 is shown. The reinforcing member 54 may include a stopper 91 at the ski's front end 81. The stopper 91 can be formed as a projection of the reinforcing member 54 rearward of the mounting shaft hole 73 on the end of the front end 81 of the reinforcing member 54. The pressing surface 93 can be formed generally below the projection, extending forward from the rearward-most point of the front end 81 to a point forward of the shaft hole 73. The pressing surface 93 preferably is formed so that when the reinforcing member is nested between the reinforcing ribs 66 and is attached to the ski body 50 through the shaft holes 73, 75 by the threaded fastener 74, the pressing surface 93 conforms to a pressed surface 95. In addition, the pressing surface 93 is positioned on or very near the pressed surface 95.

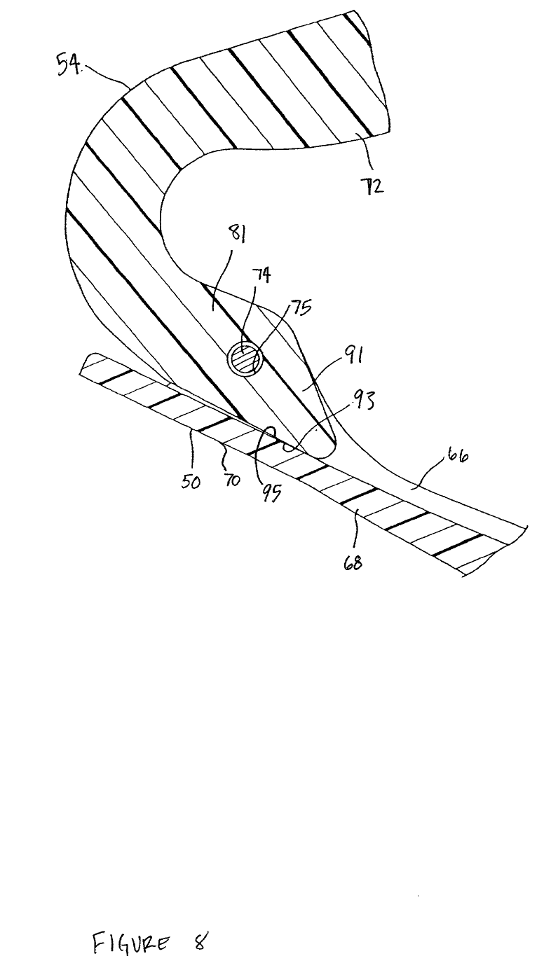

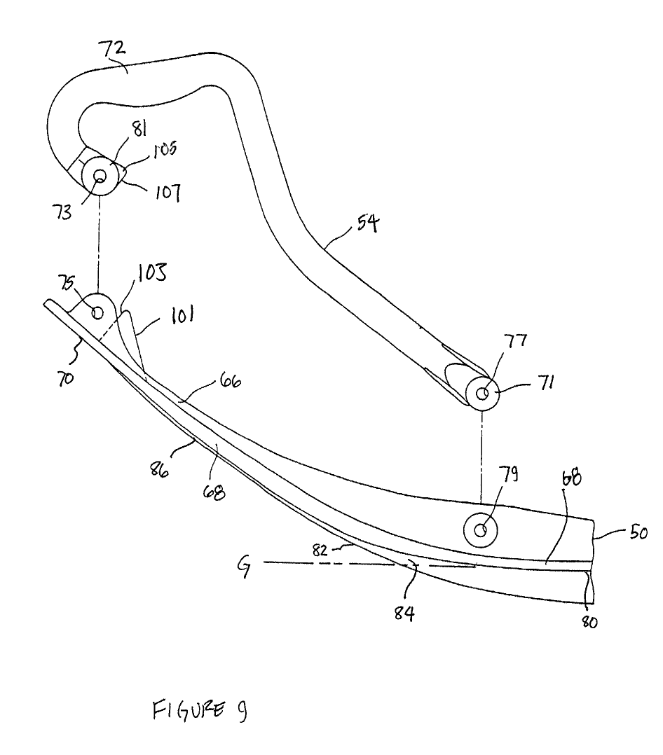

As shown in FIG. 7, the pressing surface 93 and the pressed surface 95 may not contact one another when the vehicle is in steady state. However, as shown in FIG. 8, when the vehicle strikes an obstruction or lands after becoming airborne, the pressing surface 93 comes in contact with the pressed surface 95. Under such contact, a larger surface area transmits the force of impact from the forward portion 86 of the sole 68 of the ski body 50 to the reinforcing member 54. This reduces the pressure at or around the connection point of the reinforcing member 54 and the ski body 50, thereby reducing the tendency of the ski body 50 to plastically deform. The contact area also provides a support to resist movement of the forward portion of the ski relative to the balance of the ski.

With reference now to FIG. 9, another arrangement of the stopper 91 of the reinforcement member 94 is illustrated. The arrangement may include a projection 101 formed on or attached to the top surface of the ski body 50 proximal to the shaft hole 75, for example. The projection 101 can be formed with a pressing surface 103 which rises up from the ski body at approximately a ninety degree angle to the top surface of the forward-most portion 70 of the ski body 50. Of course, other suitable angles may also be used. Also, the same projection may be formed proximal of the shaft hole 79. This arrangement also can include a small projection 105 formed on the rear-most portion of the front end 81. This small projection can include a pressed surface 107, which is made to conform to the pressing surface 103. When the front end 81 of the reinforcing member 54 is nested between the reinforcing ribs 66 and the threaded fastener 74 is passed through the shaft holes 73, 75, the pressing surface 103 and the pressed surface 107 are positioned on or in very close proximity of one another. As a result, when the vehicle 10 strikes an obstruction or lands after becoming airborne, the flexing of the forward portion 62 of ski body 50 causes the pressing surface 103 to contact the pressed surface 107.

When the vehicle 10 is in normal operation, the forces exerted on the ski pass primarily through the snow contacting portion 80. In this state, relatively small forces are exerted by the pressing surface 103 on the pressed surface 107 because most of the weight bearing forces are transmitted to the strut 32. However, when the vehicle strikes an obstruction or lands after becoming airborne, the forces transmitted from the obstruction or the ground are transmitted into the forward portion 62, through the projection 101 and into the reinforcing member 54. Specifically, the forces are transmitted over the surface area defined by the contact of the pressing surface 103 and the pressed surface 107 on the small projection 105. Because the surface area over which the forces of impact are transmitted are significantly greater than found in the conventional ski, the pressure in the ski body 50 is reduced. As a result, the likelihood of plastic deformation of the ski body is significantly reduced.

Of course this principle can be embodied in many other ways. For example, the pressing and pressed surfaces described above may also be positioned at the rear-end of the reinforcing member 54 and the on the ski near the bracket 52. Also, some applications may require locating these surfaces at both the front and rear-end mounting points of the reinforcing member. Furthermore, other force transmitting strategies could be used. For example, a restraining feature could be mounted or integrally made on the ski which passes over, but very near one or both ends of the reinforcing member and, together with a surface of the ski, defines a limited range of movement of the reinforcing member relative to the ski. Like the paired pressing and pressed surfaces of the stopper, this arrangement would constrain the movement of the ski, thereby preventing or minimizing plastic deformation. Also, a stopper may be positioned toward the front of one or both ends of the reinforcing member. In this position, the stopper would limit plastic deformation either in front of the reinforcing member front-end mounting point or in front of the reinforcing member rear-end mounting point. In this embodiment, contacting surfaces would be located on the forward-facing sides of the reinforcing member 54 just in front of the mounting points, and on the ski slightly further forward of the contacting portions on the reinforcing member.

Although this invention has been described in terms of a certain preferred arrangement, other arrangements apparent to those of ordinary skill in the art also are within the scope of this invention. Various changes and modifications may be made without departing from the spirit and scope of the invention. Accordingly, the scope of the invention is intended to be defined only by the claims that follow.

What is claimed is:

1. A ski for a vehicle comprising:
an upturned leading portion;
a reinforcing member fixed to the front of the leading portion at a forward mounting portion and to the rear of the leading portion at a rear mounting portion;
wherein the reinforcing member comprises a first stopper configured to partially conform to the surface of the leading portion in front of the forward mounting portion.

2. The ski of claim 1 further comprising a second stopper configured to partially conform to the surface of the leading portion in front of the rear mounting portion.

3. The ski of claim 1 wherein the first stopper provided in the reinforcing member extends behind the forward mounting portion.

4. The ski of claim 2 wherein the second stopper provided in the reinforcing member extends behind the forward mounting portion.

5. The ski of claim 2 wherein the first and second stopper provided in the reinforcing member extends behind the forward and rear mounting portions.

6. A ski for a snowmobile comprising:
an upturned leading portion;
a reinforcing member fixed to the front of the leading portion at a forward mounting portion and to the rear of the leading portion at a rear mounting portion; and
a stopper being connected to at least one of said ski and said reinforcing member.

7. A ski of claim 6 further comprising a first stopper configured to partially conform to the surface of the leading portion in front of the forward mounting portion.

8. The ski of claim 7 wherein the first stopper at least partially conforms to the surface of the leading portion behind the forward mounting portion.

9. The ski of claim 6 further comprising a second stopper configured to partially conform to the surface of the leading portion in front of the rearward mounting portion.

10. The ski of claim 9 wherein the second stopper at least partially conforms to the surface of the leading portion behind the rearward mounting portion.

11. The ski of claim 7 further comprising a second stopper configured to partially conform to the surface of the leading portion in front of the rearward mounting portion.

12. The ski of claim 11 wherein the second stopper section at least partially conforms to the surface of the leading portion behind the rearward mounting portion.

13. The ski of claim 8 further comprising a second stopper section configured to partially conform to the surface of the leading portion in front of the rearward mounting portion.

14. The ski of claim 13 wherein the second stopper section at least partially conforms to the surface of the leading portion behind the rearward mounting portion.

15. The ski of claim 6 further comprising a first stopper portion comprising a first projection integrally formed on the leading portion behind the front mounting portion, a second projection extending from the rearmost portion of the front end of the reinforcing member, the first and second projections arranged to contact each other at least when the upturned leading portion flexes.

16. The ski of claim 6 further comprising a first projection integrally formed on the leading portion behind the rear mounting portion, a second projection extending from the back end of the reinforcing member, the first and second projections arranged to contact each other at least when the upturned leading portion flexes.

17. The ski of claim 14 further comprising a second stopper portion comprising a third projection integrally formed on said leading portion behind the rear mounting portion, a fourth projection extending from the back end of the reinforcing member, the third and fourth projections arranged to contact each other at least when the upturned leading portion flexes.

18. The ski of claim 6 further comprising a first stopper portion configured to partially conform to the surface of the leading portion in front of the forward mounting portion, a first projection integrally formed on the leading portion behind the front mounting portion, a second projection extending from the rearmost portion of the front end of the reinforcing member, the first and second projections arranged to contact each other at least when the upturned leading portion flexes.

19. The ski of claim 6 further comprising a first stopper portion configured to partially conform to the surface of said leading portion in front of the rear mounting portion, and a second stopper portion comprising a first projection integrally formed on the leading portion behind the rear mounting portion, a second projection extending from the back end of the reinforcing member, the first and second projections arranged to contact each other at least when the upturned leading portion flexes.

20. The ski of claim 18 further comprising a third stopper portion configured to partially conform to the surface of said leading portion in front of the rear mounting portion, and a fourth stopper portion comprising a first projection integrally formed on said leading portion behind the rear mounting portion, a second projection extending from the back end of the reinforcing member, the first and second projections arranged to contact each other at least when the upturned leading portion flexes.

21. A snowmobile comprising a body, a pair of skis disposed generally below a forward portion of said body, a drive arrangement disposed generally below a rearward portion of said body, said snowmobile sliding on said pair of skis and said snowmobile being powered in at least a forward direction by said drive arrangement, at least one of said skis comprising an upturned leading portion, a reinforcing member fixed to the front of the leading portion at a forward mounting portion and to the rear of the leading portion at a rear mounting portion, and a stopper.

22. The snowmobile of claim 21 further comprising a first stopper configured to partially conform to the surface of the leading portion in front of and behind the forward mounting portion.

23. The snowmobile of claim 21 further comprising a first stopper portion configured to partially conform to the surface of the leading portion in front of the forward mounting portion, a first projection integrally formed on the leading portion behind the front mounting portion, a second projection extending from the rearmost portion of the front end of the reinforcing member, the first and second projections arranged to contact each other at least when the upturned leading portion flexes.

24. A snowmobile ski comprising a ski body, said ski body comprising a sole and an upturned forward portion, a reinforcing member connected at a forward end of said forward portion and at a second portion of said ski, said ski further comprising means for limiting relative movement between said forward portion and said ski body.
